(19) United States
(12) Patent Application Publication
(10) Pub. No.: US 2025/0121508 A1
(43) Pub. Date: Apr. 17, 2025

(54) GRIPPING OR CLAMPING DEVICE WITH MAGNETIC POSITION DETECTION

(71) Applicant: SMW-electronics GmbH, Meckenbeuren (DE)

(72) Inventor: René Hoffmann-Schneider, Lindau (DE)

(21) Appl. No.: 18/912,804

(22) Filed: Oct. 11, 2024

(30) Foreign Application Priority Data
Oct. 11, 2023 (EP) 23203056.9

(51) Int. Cl. B25J 15/00; B25J 13/08; B25J 15/08

(52) U.S. Cl. CPC B25J 15/0028; B25J 13/087; B25J 15/086

(57) ABSTRACT

In a gripping or clamping device it is important to detect the position of the clamping jaws. In the prior art this is achieved by incremental or absolute measurements which, for example, carry out optical sampling of a measuring bevel.

The present invention provides an approach that is less expensive and at the same time less susceptible to soiling, as well as space-saving. It is proposed to mount magnetic encoding on at least one clamping jaw and to evaluate this magnetic encoding by use of a magnetic sensor.

### REFERENCE TO PENDING PRIOR PATENT APPLICATION

This patent application claims benefit of European Patent Application No. 23203056.9, filed Oct. 11, 2023, which patent application is hereby incorporated herein by reference.

### FIELD OF THE INVENTION

The present invention relates to a gripping or clamping device comprising a housing with a tensioning guide, and at least one clamping jaw that is movable in this tensioning guide, wherein a position sensor for detecting a position of the at least one clamping jaw is associated with the housing.

### BACKGROUND OF THE INVENTION

Such a gripping or clamping device is already known from DE 10 2021 122 975 A1. It is provided therein that a measuring bevel which is sampled by use of a proximity sensor is incorporated into a clamping jaw. The position of the clamping jaw may be detected as a function of the distance of the proximity sensor from a section of the measuring bevel that is situated in the visual field of the proximity sensor, since the visual field of the sensor slides along the measuring bevel in the course of a displacement of the clamping jaw.

However, this approach has several drawbacks. Firstly, proximity sensors are optical sensors, which are comparatively expensive. In addition, a certain distance from the reference surface, at which the distance is determined, must be maintained in order to avoid soiling. For this purpose, a spacer sleeve is used, through which the optical detection of the measuring bevel takes place.

In addition, the subject matter of DE 10 2021 121 686 A1 is less susceptible to soiling but is comparatively expensive; in the cited publication, a coil is used to generate an electrical field, which due to the movement of the clamping element becomes detuned, and its detuning is evaluated and the distance is thus determined.

An older option for this procedure is to detect the forward feed, and commencing from a starting position, to determine how long travel took place in a direction in order to determine the position. However, this approach is inaccurate, so that it is necessary to make repeated reference trips to the starting position in order to obtain the best possible position detection.

### SUMMARY OF THE INVENTION

Proceeding from this prior art, the object underlying the present invention is to provide a gripping or clamping device which is insensitive to soiling, can be inexpensively obtained, and allows accurate position determination.

This object is achieved by a gripping or clamping device according to the features of independent claim 1. Meaningful embodiments of such a device may be inferred from the subsequent dependent claims.

In this regard, a gripping or clamping device is provided that comprises a housing with a tensioning guide, and at least one clamping jaw that is movable in this tensioning guide, wherein a position sensor for detecting a position of the at least one clamping jaw is associated with the housing. According to the invention, the gripping or clamping device is characterized in that magnetic encoding is associated with the at least one clamping jaw, and has at least the length of a clamping stroke of the at least one clamping jaw, and over this length has magnetically encoded markings that may be read out by means of a position sensor, in the form of a magnetic sensor, associated with the housing.

As a result of magnetically detecting the position from the mutual displacement between the magnetic encoding at the clamping jaw and the magnetic sensor in the housing, the position sensor may have a very space-saving design. It is not necessary, although possible, to maintain a greater distance between the magnetic encoding and the magnetic sensor. In the course of a movement of the clamping jaw, with the magnetic encoding, across the magnetic sensor, the magnetic sensor detects the alternating markings within the encoding, and within the scope of signal evaluation a conclusion may be drawn concerning the position of the clamping jaw. The evaluation of the signal of the magnetic sensor may take place in an evaluation circuit of the magnetic sensor, on a sensor board or a main board of the gripping or clamping device, or in an external control unit that is connected to a connection board via a connector.

In one particular embodiment, the magnetic encoding may be mounted on a plastic band and joined, preferably adhesively affixed, to the at least one clamping jaw. This allows use of a magnetically encoded plastic band that is already available in prefabricated form, and allows the manufacturing costs for the position sensor to be kept as low as possible. For a defined mounting and damage-free storage beforehand, the magnetically encoded plastic band may be mounted on a steel band, which is then fastened to the at least one clamping jaw.

To ensure play-free guiding of the clamping jaw in the tensioning guide, it may be meaningful for the at least one clamping jaw to have a recess for accommodating the steel band. A correctly cut-to-length magnetically encoded plastic band together with the steel band may then be introduced, preferably glued, into this recess.

Within the scope of the first start-up of the position sensor, after the positioning of the magnetic encoding a reference trip of the at least one clamping jaw is necessary. In the process, the end positions are traversed, and upon reaching the end positions the signals of the encoding, detected by the magnetic sensor, are read out. In addition, in one preferred embodiment it is possible for the magnetic encoding to represent absolute encoding, in which each magnetically encoded marking is uniquely identifiable by the magnetic sensor in a longitudinal direction of the encoding. This allows the magnetic sensor on this basis to determine, at a specific location in the encoding, how far the clamping jaw has opened or at what location it is present.

The alternative, but less preferred, approach is incremental encoding in which recurring, identical markings are placed in a longitudinal direction of the magnetic encoding. In this case it may be necessary to carry out another reference trip after a shutdown, since the individual markings are counted only upon passing by, but every single one cannot be individually identified. Since counting is meaningful only from an end position, such incremental encoding is easier, but is also subject to the stated drawback.

It may advantageously be provided that the magnetic encoding is situated on the bottom side of the at least one clamping jaw, and the magnetic sensor is situated below the tensioning guide, opposite from the at least one clamping jaw. In this way, the encoding and the magnetic sensor are in a defined position relative to one another, and the encoding is protected from external influences. However, the clamping jaws may still be moved unhindered between their end positions. Thus, an approach that is applied toward the outside as in the prior art is not necessary. Instead, this construction allows a device having a particularly compact design.

If the clamping device provides not just one, but multiple, clamping jaws, these multiple clamping jaws may also have multiple magnetic encodings. In the simplest approach, a dedicated magnetic sensor is associated with each encoding. However, in a further embodiment it may also be provided that multiple neighboring encodings are simultaneously read out by a shared magnetic sensor. This allows a redundant evaluation of multiple encodings, so that with slight deviations, an average between the positions that are ascertained from the two encodings may be determined. However, it is particularly preferred when multiple clamping jaws are provided which are synchronized with one another due to mechanical gearing. In such a case, it is necessary to provide magnetic encoding at only one clamping jaw. If a clamping jaw is motor-driven, due to the gearing the at least one other clamping jaw may be moved in the opposite direction, or in general in a similar manner, toward or away from a workpiece without the possibility of a path deviation arising.

### BRIEF DESCRIPTION OF THE DRAWINGS

The invention described above is explained in greater detail below with reference to one exemplary embodiment.

In the figures:

FIG. 1 shows a gripping or clamping device with two opposite clamping jaws in a perspective illustration,

FIG. 2 shows the gripping or clamping device according to FIG. 1 in a side cross-sectional illustration, and

FIG. 3 shows the gripping or clamping device according to FIG. 2 in a longitudinal section illustration as indicated in FIG. 2.

### DETAILED DESCRIPTION OF THE PREFERRED EMBODIMENTS

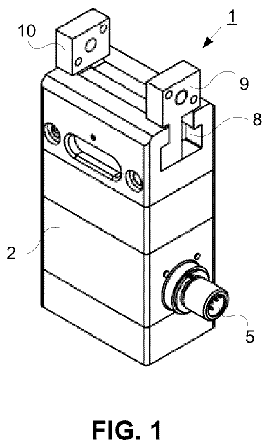

FIG. 1 shows a gripping or clamping device 1 that may be used, for example, on a robot gripper of a machine tool. The device 1 is encompassed by a housing 2 in which a tensioning guide 8 is provided. Two clamping jaws 9 and 10 that are movable along the tensioning guide 8 are provided in this tensioning guide 8. The tensioning guide 8 is designed in the form of a T-shaped undercut groove which is introduced into the housing 2 from a top side thereof. A half “T” for guiding is associated with each clamping jaw 9 and 10, wherein these guides pass by one another in such a way that clamping fingers fastened thereto are flatly movable toward one another. The adjustment of the clamping jaws 9 and 10 toward and away from one another takes place via electric motor, wherein via a connector 5, electrical energy may be provided, control commands may be delivered, and measured values may be transmitted to a control unit.

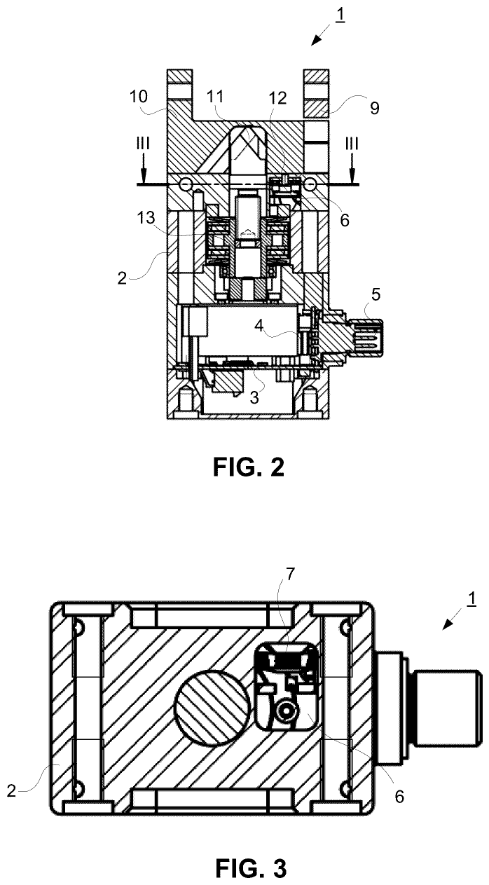

As is apparent in FIG. 2, the connector 5 is connected via a connection board 4 to a main board 3, where the control commands of the control unit, not shown here, are generated to form control commands to a drive 13. The drive 13 activates the clamping jaws 9 and 10 via gearing 11, and the clamping jaws are by necessity thus operated synchronously with one another. Therefore, it is sufficient for magnetic encoding 12 in the form of a plastic band to be associated only with the first clamping jaw 9, the plastic band being adhesively affixed to the bottom side of the first clamping jaw 9, facing a sensor 7 on a sensor board 6. While the clamping jaw 9 is being moved across the magnetic sensor 7 in the direction of the tensioning guide 8, the magnetic sensor 7 reads out the magnetic encoding 12, and in the case of absolute encoding can read off the position of the first clamping jaw 9 with respect to the housing 2 at each individual marking, which analogously also gives the position of the second clamping jaw 10 due to the gearing 11. The bearing of the magnetic sensor 7 on the sensor board 6 within the housing 2 of the device is shown once more in FIG. 3. The sensor board 6 is situated off-center in the housing 2, so that the magnetic sensor 7 can optimally read out the magnetic encoding 12, which is affixed only to a first clamping jaw 9.

Thus, a gripping or clamping device is described above which is insensitive to soiling, can be inexpensively obtained, and allows accurate position determination.

### LIST OR REFERENCE NUMERALS

1 gripping or clamping device
2 housing
3 main board
4 connection board
5 connector
6 sensor board
7 magnetic sensor
8 tensioning guide
9 first clamping jaw
10 second clamping jaw
11 gearing
12 magnetic encoding
13 drive

1. A gripping or clamping device, comprising a housing (2) with a tensioning guide (8), and at least one clamping jaw (9, 10) that is movable in this tensioning guide (8), wherein a position sensor for detecting a position of the at least one clamping jaw (9, 10) is associated with the housing (2), characterized in that magnetic encoding (12) is associated with the at least one clamping jaw (9, 10), and has at least the length of a clamping stroke of the at least one clamping jaw (9, 10), and over this length has magnetically encoded markings that may be read out by means of a position sensor, in the form of a magnetic sensor (7), associated with the housing (2).

2. The gripping or clamping device according to claim 1, characterized in that the magnetic encoding (12) is mounted on a plastic band and is joined, preferably adhesively affixed, to the at least one clamping jaw (9, 10).

3. The gripping or clamping device according to claim 2, characterized in that the magnetically encoded plastic band is mounted on a steel band, which is fastened to the at least one clamping jaw (9, 10).

4. The gripping or clamping device according to claim 3, characterized in that the at least one clamping jaw (9, 10) has a recess for accommodating the steel band.

5. The gripping or clamping device according to claim 1, characterized in that the magnetic encoding (12) represents absolute encoding, in which each magnetically encoded marking is uniquely identifiable by the magnetic sensor (7) in a longitudinal direction of the encoding (12).

6. The gripping or clamping device according to claim 1, characterized in that the magnetic encoding (12) encompasses incremental encoding in which recurring, identical markings are placed in a longitudinal direction of the magnetic encoding (12).

7. The gripping or clamping device according to claim 1, characterized in that the magnetic encoding (12) is situated on the bottom side of the at least one clamping jaw (9, 10), and the magnetic sensor (7) is situated below the tensioning guide (8), opposite from the at least one clamping jaw (9, 10).

8. The gripping or clamping device according to claim 1, characterized in that multiple clamping jaws (9, 10) are provided, and have multiple magnetic encodings (12).

9. The gripping or clamping device according to claim 8, characterized in that multiple magnetic encodings (12) may be simultaneously read out by a shared magnetic sensor (7).

10. The gripping or clamping device according to claim 1, characterized in that multiple clamping jaws (9, 10) are provided which are synchronized with one another due to mechanical gearing (11), and magnetic encoding (12) is provided at only one clamping jaw (9, 10).
